(19) United States
(12) Patent Application Publication
(10) Pub. No.: US 2017/0211615 A1
(43) Pub. Date: Jul. 27, 2017

(54) AXIAL SLIDING BEARING

(71) Applicants: JOINT STOCK COMPANY "CENTRAL DESIGN BUREAU OF MACHINE BUILDING", St. Petrsburg (RU); SC "ATOMENERGOMASH", Moscow (RU)

(72) Inventors: Vladimir Sergeevich GERASIMOV, St. Peterburg (RU); Sergei Pavlovich EVTUSHENKO, St. Peterburg (RU); Rodion Petrovich KAZANTSEV, St. Peterburg (RU); Sergei Arkadyevich NIKIFOROV, Leningradskaya obl., g. Pushkin (RU); Aleksandr Sergeevich SEMYONOVYKH, St. Peterburg (RU); Sergei Yuryevich SHCHUTSKY, St. Peterburg (RU)

(21) Appl. No.: 15/327,983

(22) PCT Filed: Jul. 21, 2014
(86) PCT No.: PCT/RU2014/000537

§ 371 Date: Jan. 20, 2017

(51) Int. Cl. F16C 17/08; F16C 35/02

(52) U.S. Cl. CPC F16C 17/08; F16C 35/02; F16C 2206/02

(57) ABSTRACT

The invention relates to plain thrust bearings, wherein one working surface of which is made of siliconized graphite (or other antifriction material with similar characteristics) and can be used in assemblies of electrical machines and hydraulic machines having thrust bearings of a large size (with a diameter up to 900 mm), preferably electric motors driving a main circulation pump assembly (MCPA) of reactor assemblies, for example, in nuclear power plants. The plain thrust bearing comprises interleaving bearing bands and slots on the side facing to a set of sector. The bearing disk is provided with mounting surfaces, wherein external and internal rings securing the sectors made of antifriction material through elastic elements are mounted on the mounting surfaces. The sectors are fixed to deter them from rotation relative the bearing ring by intermediate bars arranged between the sectors, wherein the bars are fixed by inserting their pins into the openings in the bearing disk. The sectors made of antifriction material are provided with steps for the external and internal rings, wherein upper parts of the sectors are provided with roundings and lower parts of the sectors are provided with slots for mutual axial fixation. A sector's lead-in edge is shaped approximately as a parabolic curve. Cooling and lubricating is carried out through interleaving channels formed by the bars, the sectors, the external and the internal rings.

### INCORPORATION BY REFERENCE TO RELATED APPLICATIONS

This application is a U.S. national stage entry of, and claims priority to, PCT Application No. PCT/RU2014/000537, filed on Jul. 21, 2014 (International Publication No. WO/2016/013952), which is hereby incorporated herein by reference in its entirety and is to be considered a part of this specification.

### BACKGROUND OF THE INVENTION

Field of the Invention

The invention relates to plain thrust bearings with at least one working surface made of siliconized graphite (or other antifriction material with similar characteristics). The main area of its use is corresponding structural assemblies of electrical machines and hydraulic machines having thrust bearings of a large size (with a diameter up to 900 mm), preferably electric motors driving a main circulation pump assembly (MCPA) and the main circulation pump assemblies of water-cooled reactor assemblies, for example, in a nuclear power plant (NPP) themselves.

Description of the Related Art

Siliconized graphite (as antifriction material for bearings) is characterized as heat-resistant material (at least up to 300° C.) and enables use of water instead of oil as lubricant coolant. This solution is used in radial and thrust bearings of vane-type pumps, which are included by the MCPA.

However, due to brittleness, a lower linear expansion coefficient than that of metal, complexity of manufacturing process of a plate as an integral unit of maximal overall dimensions up to 900 mm and complications in providing uniform and effective heat removal from a friction zone if the integral plate is used, manufacturing of the plates for the plain thrust bearings of the large diameter with use of siliconized graphite lubricated and cooled by water as antifriction material is impossible.

There are known plain thrust bearings for powerful steam turbine mounted on a shaft having a collar moving between two sets of sliders with Kingsbury's leveling lever system, wherein oil is used as cooling and lubricant fluid (see Serezhkina L. P., Zaryetsky E. I., Thrust bearings for powerful steam turbines, Mashinostroenie, 1988, pp. 39 to 41).

A disadvantage of the known thrust bearings using oil as cooling and lubricant fluid is increase of fire hazardous of nuclear power plant equipment including main circulation pumps functioning in non-occupied area. To provide fire safety, a noncombustible lubricating and cooling fluid, in particular water, should be used. Use of water requires changes in construction, particularly a plate made with use of antifriction material functionally operative under cooling and lubricating by water should be installed on the collar.

There is known a plain thrust bearing comprising a body and a collar with a flange fixed on a shaft, wherein a bearing disk is mounted on a bearing surface of the collar and an assembly having self-aligning sliders provided with antifriction plates contacting with the disk by their bearing surfaces is placed between the body and the disk (see Patent No. RU2242645, F16C 17/04, published Jul. 15, 2003). The bearing includes a draw ring having windows (separator) for the antifriction plates and secured to a working surface of the assembly provided with the self-aligning sliders and the antifriction plates made as bushings and free accommodated by windows of the draw ring, wherein a working surface of the antifriction bushings project over a butt surface of the draw ring. The bearing disk is made as a solid antifriction ring. The antifriction bushings are step shaped in cross-section, wherein the steps deter the bushings from falling out from the windows of the draw ring.

The disadvantage of the known plain thrust bearing is use of the disk formed as the solid antifriction ring made as a monoblock on the flange (collar), which is impossible in a case of the thrust bearing of a large size (when the diameter is up to 900 mm). Moreover, load balancing in a contact area by means of the axially springing ring provided with the bushings made of antifriction material is impossible in the plain thrust bearing on large unit loading.

There is known a plain thrust bearing assembly comprising a body and a shaft provided with a flange, wherein a disk having circumferential projections is installed on a bearing surface of the flange and self-aligning sliders are arranged between the body and the disk in contact with the disk by their working surfaces (see Patent No. RU1745004, F16C 17/04, published Feb. 28, 1994).

This is known technical solution enabling functioning of the plain thrust bearing under large unit loading with use of antifriction plates made of siliconized graphite in a case of use of water as a lubricating and cooling fluid and has such disadvantages that unit loadings to self-adjusting sectors are not balanced and that hydrodynamic influence of lubricating and cooling fluid flow results in erosion damages during long-term functioning of the large-sized plain trust bearing.

### SUMMARY OF THE INVENTION

The object of the invention is to form by a plate a contact surface of a shaft collar for a given large-sized plain thrust bearing provided with a Kingsbury's leveling lever system and functioning with use of siliconized graphite (or other materials having close characteristics) as antifriction material under condition of cooling and lubricating the bearing by water, which correspond to exploitation of the MCPA in the NPP.

By embodiment of the proposed invention the following technical results can be achieved:
decrease of risk to damage antifriction elements made of siliconized graphite by bending stresses and thermal deformations due to unevenness of heat removal from a contact zone when solid form of the plate is used;
improvement of circulation of cooling and lubricating water on the surface of the plain thrust bearing collar;
improvement of manufacturability of the plate for the collar of the large-sized plain thrust bearing;
providing the repairability of the plate for the collar of the large-sized plain thrust bearing;
increase of reliability;
decrease of fire hazardous; and
deterring sector set from rotation along a bearing disk.

As an object solution enabling achievement of the effect with the said characteristics there is provided a plain thrust bearing comprising a body and a shaft provided with a flange, wherein a disk having circumferential projections is mounted on a bearing surface of the flange and self-aligning sliders are arranged between the body and the disk in contact with the disk by their working surfaces, wherein the self-aligning sliders are provided with antifriction plates, wherein two circumferential projections are made on the bearing surface of the disk and antifriction segments are installed on the working surface of the disk. According to the invention, it is proposed to provide the bearing disk with interleaving bearing bands and slots on the side directed to the sector set, to provide the bearing disk on its internal and external diameters with mounting surfaces, wherein external and internal rings fixing sectors made of antifriction material through elastic elements are secured the mounting surfaces, to fix the sectors to deter them from rotation in relation to the bearing ring by placing spacing bars between the sectors, wherein the bars are fixed by inserting a bar pin into the openings in the bearing disk, to provide the sectors made of antifriction material with steps for the external and internal rings, to provide an upper part of sectors with radius rounding and a lower part with slots ensuring mutual axial fixation, to shape a sector's lead-in edge approximately as a parabolic curve, to cool and lubricate through interleaving channels formed by the bars, the sectors, the external and the internal rings.

It is preferable to fix the plates to collar in an intermediate space between the bearing bands by bolts or screws lockable to deter from self-unbolting.

The sectors advantageously are made of siliconized graphite or silicon carbide.

The technical results are achieved in the following way.

To reduce risks to damage the sectors made of siliconized graphite (or other material having close characteristics) and to decrease transfer of bending deformations and thermal deformation to the sectors from the collar during working operation, the bearing disk comprises the bearing bands on the side facing to the collar, wherein the bands are made in a zone close to a center of equilibrium of internal and external surfaces of the sectors made of siliconized graphite.

To deter the set of the sectors from rotation along the bearing disk during working operation each sector is locked by a side surface of the (intermediate) spacing bar placed between the sectors. The spacing bars are fixed in relation to the bearing disk by the bar pin inserted into the opening of the bearing disk; locking is carried out by bars having a mounting pins and installed at the beginning and the end of the sectors group. The bars, the (profiled) sectors made of siliconized graphite (or other material having close characteristics), and the external and internal fixing rings form the channels ensuring improvement of circulation of cooling and lubricating water on the contact surface of the collar of the plain thrust bearing during working operation.

Use of the set of the sectors made of siliconized graphite (or other antifriction material having close characteristics) ensures improvement of manufacturability of the collar plate for the plain thrust bearing of large size.

Replaceability of the separated sectors of the plate during manufacturing and exploitation ensures repairability of the collar plate for the plain thrust bearing of large size.

To reduce fire hazardous of the nuclear power plant equipment including the main circulation pumps functioning in non-occupied area, the noncombustible cooling and lubricating fluid, i.e., water, is used and the plate made with use of antifriction material functioning when they are cooled and lubricated by water is mounted on the collar.

### BRIEF DESCRIPTION OF THE DRAWINGS

Features, aspects and advantages are described below with reference to the drawings, which are intended to illustrate but not to limit the invention. The claimed invention in particular embodiment is illustrated in FIGS. 1-8.

FIG. 1 depicts an embodiment of a plain thrust bearing.

FIG. 2 depicts a plate of the plain thrust bearing (a general view).

FIG. 3 depicts channels of the plate (view B of FIG. 2).

FIG. 4 depicts the plate (a cross-sectional view taken along A-A of FIG. 2).

FIG. 5 depicts a plate sector (a general view).

FIG. 6 depicts the plate sector (a side view of FIG. 5).

FIG. 7 depicts a plate bar (a general view).

FIG. 8 depicts the plate bar (view C of FIG. 7).

### DETAILED DESCRIPTION OF THE PREFERRED EMBODIMENT

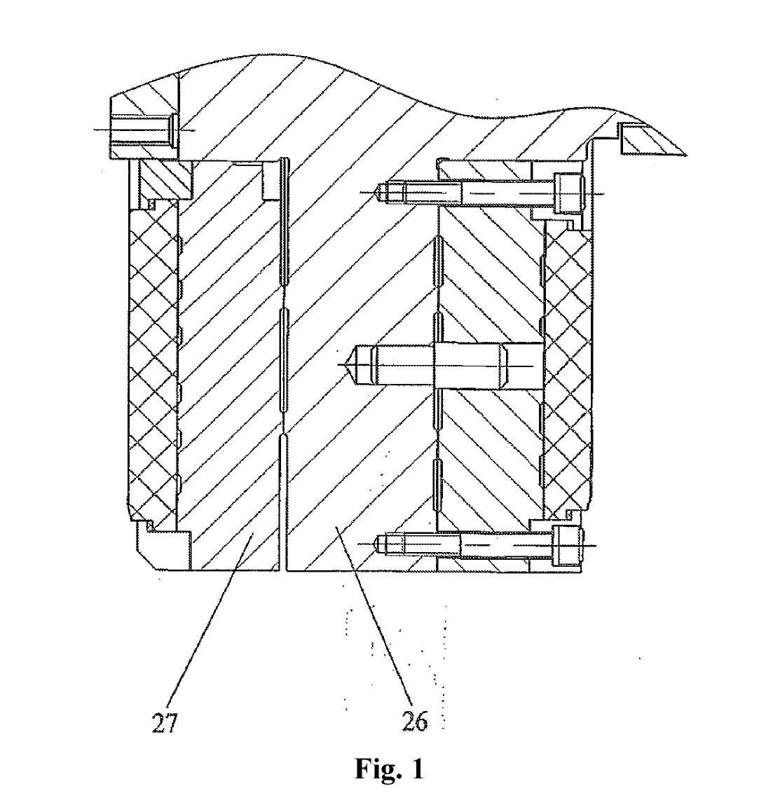

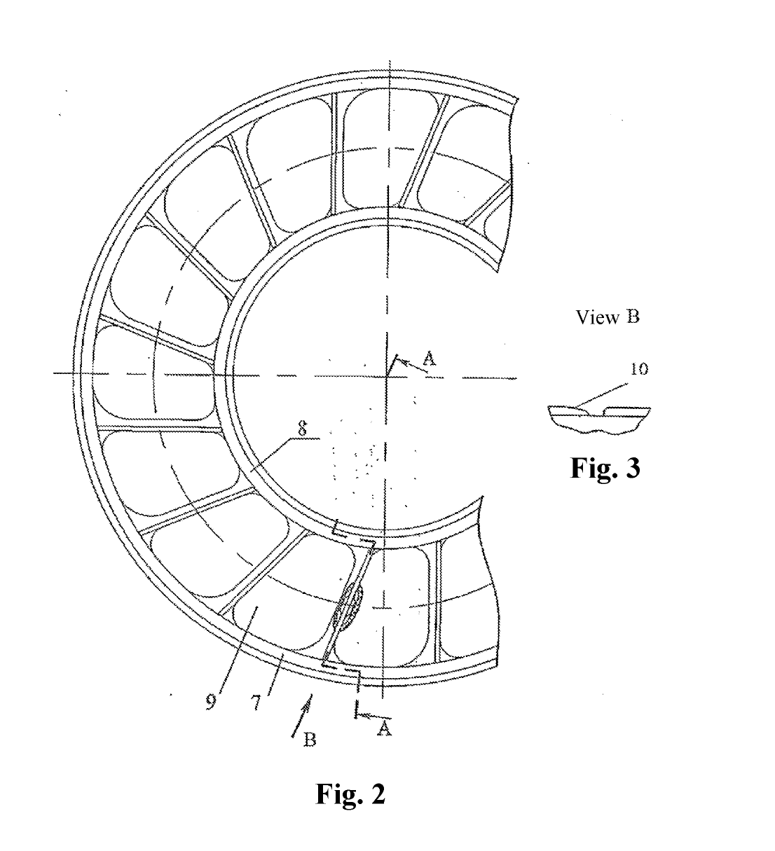

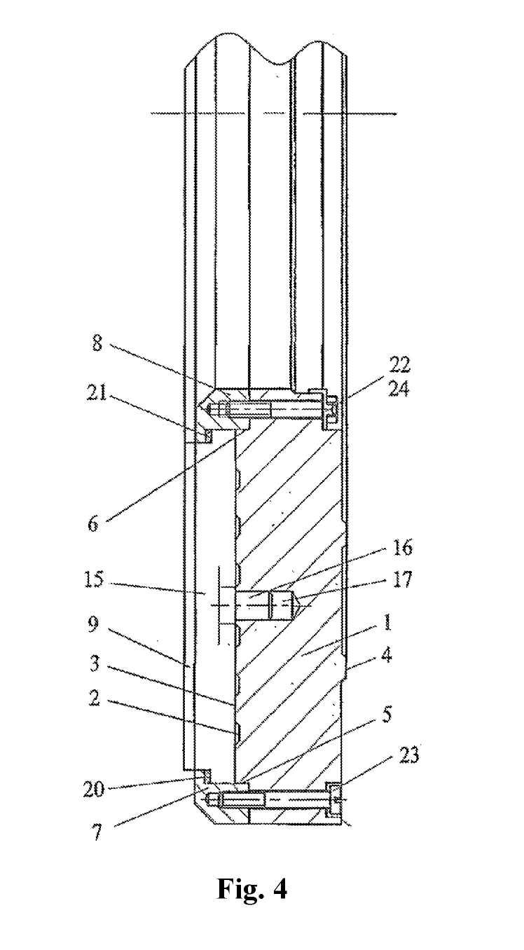

The plain thrust bearing of large size is embodied in a body (not shown) and is mounted on a collar of a shaft. The bearing is provided with the collar 26 moving between two sets of sliders and provided with Kingsbury's leveling lever system placed between the body and the bearing disk 1 (FIG. 4) and the plates 27 mounted on the collar (see FIG. 1). The plate 27 (FIG. 2) includes the bearing disk 1 (FIG. 4) embodied as a ring having a mounting surface along an internal diameter.

The bearing disk 1 has a surface comprising interleaving slots 2 and bearing bands 3 ensuring bearing conditions required by siliconized graphite strength conditions and, at the same time, providing with minimal area size for treatment of the mutual adjoining surface on the side facing to a set of sectors (FIG. 4).

The bearing disk 1 is provided with two bearing bands 4 (FIG. 4) on the side facing to the collar 26. The bearing bands are arranged in a zone situated closely to an equilibrium center of internal and external surfaces of the sectors made of siliconized graphite in order to reduce risk to damage the sectors and to reduce transfer of bending deformations and thermal deformations to the sectors from the collar during working functioning.

Circular grooves (steps) 5, 6 coaxial to the mounting surface of the bearing disk are made along internal and external diameters of the bearing disk 1 (FIG. 4) on the side facing to the sectors in order to center corresponding external and internal rings 7, 8. The set of the sectors 9 (FIGS. 2 and 4) made of siliconized graphite and geometrically shaped as sectors provided with working contact surfaces is mounted on the upper bearing surface of the bearing ring 1. Use of the set of the sector made of siliconized graphite ensures improvement of manufacturability of the plate of the collar for large-sized plain thrust bearing and increase of reliability and repairability during exploitation.

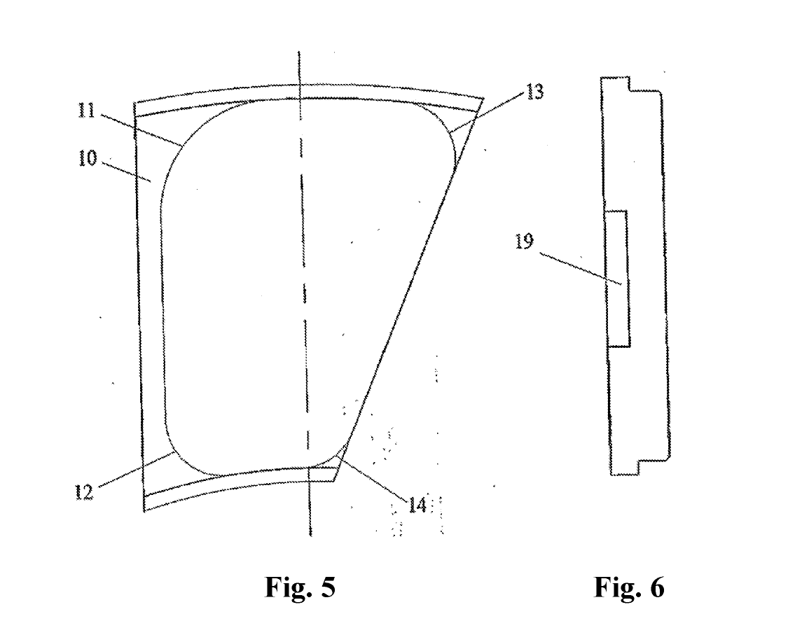

To prevent hydrodynamic disturbances, the lead-in edge 10 (FIGS. 2 and 5) of the sector 9 is deflected from the radial direction to the direction of rotation on the area of the sector with the bigger diameter. To ensure smooth change of direction of cooling and lubricating water flow from circumferential to radial one and vice versa in slots near inlets and outlets between the sectors, the lead-in edge 10 of the sector is shaped approximately as a parabolic curve (FIG. 3) and corresponding radial roundings 11, 12, 13, 14 (FIG. 5) are made along external and internal contour. Due to use of water as the cooling and lubricating fluid fire safety is ensured.

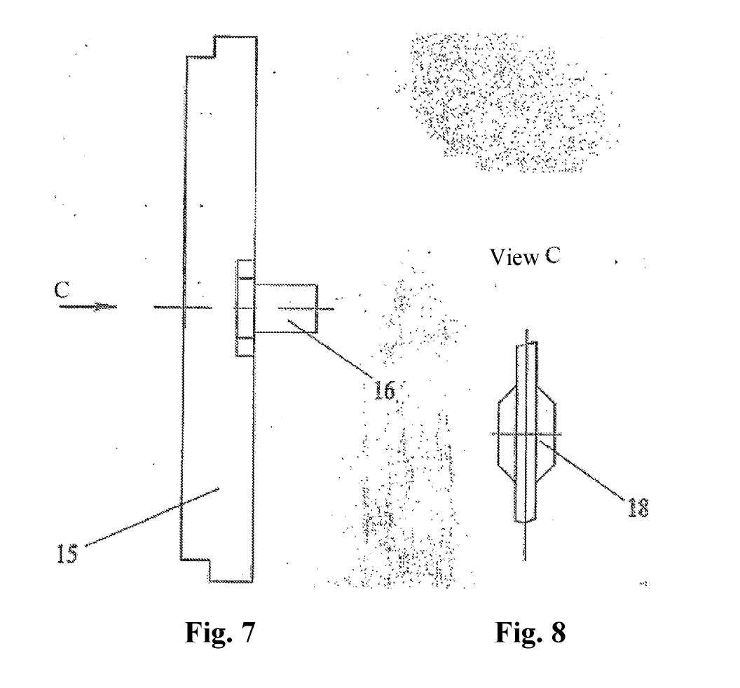

The sectors 9 are fixed to deter from rotation along the bearing disk 1 during working functioning with use of side surfaces of (intermediate) bars 15 (FIGS. 4 and 7). When the bar is being mounted, the pin 16 is inserted into the opening 17 in the bearing disk and stoppers 18 (FIG. 8) are inserted into the slots 19 (FIG. 6) of the sectors. This provides mutual axial fixation.

The sectors 9 are mounted along the bearing disk 1 (FIG. 4) by the external 7 and the internal 8 rings and elastic elements 20 and 21 (FIG. 4).

The sectors 9 are additionally fixed to deter from rotation along the bearing disk 1 by stopping (wedging) the sectors in relation to the external 7 and the internal 8 rings.

The fixing external 7 and internal 8 rings are secured to the disk by, particularly, the bolts 22 and the screws 23 (FIG. 4) and the stopping washers 24 and 25 (FIG. 4).

The plate 27 of the plain thrust bearing is secured to the collar 26 in the space between the bearing bands 4 (in particular case, by bolts or screws provided with stoppers deterring them from self-unbolting).

The plate is assembled by arranging the bars 15 on the bearing disk 1 and following arranging the sectors 9, the elastic elements 20, 21 and the fixing external 7 and internal 8 rings, and then they are secured to the bearing disk.

Each of the foregoing and various aspects, together with those set forth in the claims and described in connection with the embodiments of the bearing summarized above or otherwise disclosed herein including the drawings may be combined as claim limitations for a device, apparatus, system, method of manufacture, and/or use.

Although the various inventive aspects are herein disclosed in the context of certain preferred embodiments, implementations, and examples, it should be understood by those skilled in the art that the present invention extends beyond the specifically disclosed embodiments to other alternative embodiments and/or uses of the invention and obvious modifications and equivalents thereof. In addition, while a number of variations of the various aspects have been shown and described in detail, other modifications, which are within their scope will be readily apparent to those of skill in the art based upon this disclosure. It should be also understood that the scope this disclosure includes the various combinations or sub-combinations of the specific features and aspects of the embodiments disclosed herein, such that the various features, modes of implementation, and aspects of the disclosed subject matter may be combined with or substituted for one another. Thus, it is intended that the scope of the present invention herein disclosed should not be limited by the particular disclosed embodiments or implementations described above.

1. A plain thrust bearing comprising:
a body and a shaft provided with a flange,
a bearing disk having circumferential projections is mounted on a bearing surface of the flange and self-aligning sliders are mounted between the body and the bearing disk in contact with the bearing disk by their working surfaces, wherein the self-aligning sliders are provided with antifriction plates, wherein the circumferential projections are made on the bearing surface of the bearing disk,
antifriction segments mounted on the working surface of the bearing disk,
wherein the bearing disk is provided with interleaving bearing bands and slots on a side facing to a set of sectors,
wherein the bearing disk is provided with mounting surfaces along its internal and external diameters,
wherein external and internal rings securing the sectors made of antifriction material through elastic elements are mounted on the mounting surfaces, the sectors are fixed to deter them from rotation in relation to the bearing ring by intermediate bars arranged between the sectors,
wherein the bars are fixed by inserting their pins into the openings in the bearing disk,
wherein the sectors made of antifriction material are provided with steps for the external and internal rings,
wherein upper parts of the sectors are provided with roundings and lower parts of the sectors are provided with slots for mutual axial fixation,
wherein a sector's lead-in edge is shaped approximately as a parabolic curve,
wherein interleaving channels for cooling and lubricating are formed by the bars, the sectors, the external and the internal rings.

2. The plain thrust bearing according to claim 1, wherein the plate is secured to the collar by bolts or screws lockable to deter from self-unbolting in an intermediate space between the bearing bands.

3. The plain thrust bearing according to claim 1, wherein the sectors are made of siliconized graphite or silicon carbide.
